(19) United States
(12) Patent Application Publication
(10) Pub. No.: US 2025/0361160 A1
(43) Pub. Date: Nov. 27, 2025

(54) WASTEWATER SEPARATOR AND METHOD OF SEPARATING A FLOW OF WASTEWATER

(71) Applicant: S3NERGY INC. d/b/a REGENEAU, Québec (CA)

(72) Inventor: David PINEAULT, Lévis (CA)

(21) Appl. No.: 18/873,851

(22) PCT Filed: Jun. 16, 2023
(86) PCT No.: PCT/CA2023/050833

§ 371 Date: Dec. 11, 2024

Related U.S. Application Data
(60) Provisional application No. 63/353,197, filed on Jun. 17, 2022.

(51) Int. Cl. C02F 1/38; B04C 3/00; B04C 3/06; B04C 9/00; C02F 103/00; F28D 21/00

(52) U.S. Cl. CPC C02F 1/385; B04C 3/06; B04C 9/00; F28D 21/0012; B04C 2003/006; C02F 2103/002; C02F 2103/005; C02F 2301/026; C02F 2303/10

(57) ABSTRACT

There is described a wastewater separator for separating a flow of wastewater. The wastewater separator generally has: an axis: an inlet chamber defined around the axis and having a wastewater inlet defining a vortex: an outlet chamber defined around the axis below the inlet chamber and having a solid outlet and a liquid outlet: an annular neck between the inlet chamber and the outlet chamber and defining an opening at a bottom of the inlet chamber. the inlet chamber tapering to the annular neck and the outlet chamber inverse-tapering from the annular neck: and an assembly of angularly inclined fins circumferentially distributed around the axis and axially located between the annular neck and the solid outlet. the angularly inclined fins having an upper edge in fluid communication with a lower portion of the annular neck and a lower edge circumferentially spaced apart from the upper edge along the vortex.

### FIELD

The improvements generally relate to the treatment of wastewater, and more specifically relate to the separation of solid matter from liquid of such wastewater.

### BACKGROUND

Wastewater generally refers to used water from domestic, commercial, industrial and/or agricultural activities. Wastewater can include different types of water such as blackwater and greywater. As blackwater refers to wastewater from toilets including feces, urine, toilet paper and/or water, greywater refers to wastewater without fecal contamination. Sources of greywater can include sinks, washing machines, dishwashers and showers. In some applications, wastewater separators are used to separate solid matter such as feces and toilet paper from the wastewater prior to unloading into the sewage.

U.S. Pat. No. 4,547,917 describes a wastewater separator with an inlet pipe having a widened bottom portion, an outlet pipe having a widened top portion and a liquid container which sealingly encloses end portions of the inlet and outlet pipes. The diameter of the top end of the outlet pipe is equal to of larger than the diameter of the non-widened portion of the inlet pipe, and the diameter of the bottom end of the inlet pipe is larger than the diameter of the top portion of the outlet pipe. Discharge piping may be connected peripherally to the inlet pipe of the wastewater separator, and the inlet pipe may have several wires provided spaced round the periphery thereof and extending down towards the center of the outlet pipe for guiding solid matter received from the inlet pipe to the center of the outlet pipe.

Although existing wastewater separators were found to be satisfactory to a certain degree, there remains room for improvement.

### SUMMARY

It was found that the wires generally used in existing wastewater separators to guide solid matter into the outlet pipe can be prone to clogging. Indeed, due to the downward orientation, thinness and/or spacing of the wires, and as the wastewater circulates in a spiral or vortex movement inside the inlet pipe, the solid matter such as toilet paper tend to wrap around the downwards wires and dry up in that position. Accordingly, existing wastewater separators typically require regular maintenance to remove the accumulation of dried toilet paper wrapped around the downward wires, for instance.

There is thus described a wastewater separator having a vortex axis, an inlet chamber defined around the vortex axis and having a wastewater inlet defining a vortex direction of rotation, and an outlet chamber defined around the vortex axis below the inlet chamber and having a solid outlet and a liquid outlet. The wastewater separator is provided with an annular neck between the inlet chamber and the outlet chamber thus defining an opening at a bottom of the inlet chamber. The inlet chamber tapers to the annular neck and the outlet chamber inverse-taper from the annular neck. In this way, the inlet chamber, the annular neck and the outlet chamber collectively form a hourglass shape having a continuous waist at the annular neck. On one hand, the solid matter generally tends to fall into the opening and then into the solid outlet. On the other hand, the liquid general tends to be attracted to the generally convex shape of the annular neck via Coandă effect which directs the liquid into the liquid outlet of the outlet chamber. The wastewater separator is further equipped with an assembly of angularly inclined fins circumferentially distributed around the vortex axis and axially located between the annular neck and the solid outlet. Each angularly inclined fin has an upper edge in fluid communication with a lower portion of the annular neck and a lower edge circumferentially spaced apart from the upper edge along the vortex direction of rotation. As the fins are oriented along the vortex direction of orientation, the solid matter and liquid can glide against the angularly inclined fins without resistance, thereby preventing solid matter such as toilet paper from clogging or otherwise wrapping around any one of the fins.

In accordance with a first aspect of the present disclosure, there is provided a wastewater separator for separating a flow of wastewater having solid matter and liquid, the wastewater separator comprising: a vortex axis; an inlet chamber defined around the vortex axis and having a wastewater inlet defining a vortex direction of rotation; an outlet chamber defined around the vortex axis below the inlet chamber and having a solid outlet and a liquid outlet; an annular neck between the inlet chamber and the outlet chamber and defining an opening at a bottom of the inlet chamber, the inlet chamber tapering to the annular neck and the outlet chamber inverse-tapering from the annular neck; and an assembly of angularly inclined fins circumferentially distributed around the vortex axis and axially located between the annular neck and the solid outlet, the angularly inclined fins having an upper edge in fluid communication with a lower portion of the annular neck and a lower edge circumferentially spaced apart from the upper edge along the vortex direction of rotation.

Further in accordance with the first aspect of the present disclosure, the angularly inclined fins can for example be made of polymer.

Still further in accordance with the first aspect of the present disclosure, the angularly inclined fins can for example have a lower surface with a convex ending portion leading to the lower edge.

Still further in accordance with the first aspect of the present disclosure, the assembly of angularly inclined fins can for example include at least 10 fins, preferably at least 15 fins and more preferably at least 20 fins.

Still further in accordance with the first aspect of the present disclosure, the assembly of angularly inclined fins can for example have an inner diameter being greater than an inner diameter of the opening.

Still further in accordance with the first aspect of the present disclosure, the inlet chamber can for example have a top lid removably mounted to the inlet chamber.

Still further in accordance with the first aspect of the present disclosure, the outlet chamber can for example have an annular shape, the solid outlet can for example be axially disposed below the opening and extending along the vortex axis through the annular shape of the outlet chamber.

Still further in accordance with the first aspect of the present disclosure, the assembly of angularly inclined fins can for example have an inner diameter being smaller than an inner diameter of the solid outlet.

Still further in accordance with the first aspect of the present disclosure, the outlet chamber can for example have a liquid inlet being annularly disposed around the solid outlet.

Still further in accordance with the first aspect of the present disclosure, the liquid inlet can for example form an annular nozzle directed towards the assembly of angularly inclined fins.

Still further in accordance with the first aspect of the present disclosure, the wastewater separator can for example further comprise a batch recipient in fluid communication with the solid outlet for accumulating a batch of solid matter.

In accordance with a second aspect of the present disclosure, there is provided a method of separating a flow of wastewater using a separator having a vortex axis, an inlet chamber defined around the vortex axis, an outlet chamber defined around the vortex axis below the inlet chamber, an annular neck between the inlet chamber and the outlet chamber and defining an opening at a bottom of the inlet chamber, the method comprising: circulating the flow of wastewater in a vortex within the inlet chamber; the annular neck guiding some circulating liquid of the flow outwardly around a solid outlet axially extending within the outlet chamber and into the outlet chamber; and using an assembly of angularly inclined fins distributed around the vortex axis and axially located between the annular neck and the solid outlet, guiding some circulating solid matter of the flow into the opening towards the solid outlet, the fins defining paths being continuous to the vortex of the inlet chamber.

Further in accordance with the second aspect of the present disclosure, some circulating liquid of the flow can for example clean the assembly of angularly inclined fins.

As can be understood, wastewater can include hot water carrying a significant amount of thermal energy. Most of the time, the thermal energy carried by wastewater is overlooked and lost through the sewage. However, in some applications, the thermal energy carried by the wastewater is extracted on-site prior to the discharge of the wastewater into the sewage. In these applications, it is generally preferably to separate the solid matter from the waste water prior to heat extraction to avoid clogging.

In accordance with a third aspect of the present disclosure, there is provided a wastewater heat exchanger comprising: a wastewater conduit; a wastewater separator having a vortex axis, an inlet chamber defined around the vortex axis, the inlet chamber having a wastewater inlet in fluid communication with the wastewater conduit and defining a vortex direction of rotation, an outlet chamber defined around the vortex axis below the inlet chamber and having a solid outlet and a liquid outlet, an annular neck between the inlet chamber and the outlet chamber and defining an opening at a bottom of the inlet chamber, the inlet chamber tapering to the annular neck and the outlet chamber inverse-tapering from the annular neck; and a heat exchanger unit having a coolant liquid inlet and a separated liquid inlet in fluid communication with the liquid outlet of the wastewater separator, the heat exchanger unit being configured for exchanging heat between the liquid received from the liquid outlet of the wastewater separator and coolant liquid of the coolant liquid inlet.

Further in accordance with the third aspect of the present disclosure, the wastewater separator can for example further comprise an assembly of angularly inclined fins circumferentially distributed around the vortex axis and axially located between the annular neck and the solid outlet, the angularly inclined fins can for example have an upper edge in fluid communication with a lower portion of the annular neck and a lower edge circumferentially spaced apart from the upper edge along the vortex direction of rotation.

Still further in accordance with the third aspect of the present disclosure, the angularly inclined fins can for example be made of polymer.

Still further in accordance with the third aspect of the present disclosure, the angularly inclined fins can for example have a lower surface with a convex ending portion leading to the lower edge.

Still further in accordance with the third aspect of the present disclosure, the assembly of angularly inclined fins can for example include at least 10 fins, preferably at least 15 fins and more preferably at least 20 fins.

Still further in accordance with the third aspect of the present disclosure, the assembly of angularly inclined fins can for example have an inner diameter being greater than an inner diameter of the opening.

Still further in accordance with the third aspect of the present disclosure, the inlet chamber can for example have a top lid removably mounted to the inlet chamber.

All technical implementation details and advantages described with respect to a particular aspect of the present disclosure are self-evidently mutatis mutandis applicable for all other aspects of the present disclosure.

Many further features and combinations thereof concerning the present improvements will appear to those skilled in the art following a reading of the instant disclosure.

### DESCRIPTION OF THE FIGURES

In the figures,

FIG. 1 is a schematic view of an example of a wastewater heat exchanger, shown with an exemplary wastewater separator, in accordance with one or more embodiments;

FIG. 2A is an oblique view of an example of a wastewater separator, in accordance with one or more embodiments;

FIG. 2B is a sectional view of the wastewater separator of FIG. 2A taken along section 2B-2B of FIG. 2A, shown with an assembly of angularly inclined fins, in accordance with one or more embodiments;

FIG. 2C is a top plan view of the wastewater separator of FIG. 2A, shown with a removable lid thereof taken off, in accordance with one or more embodiments;

FIG. 2D is an enlarged view of the assembly of angularly inclined fins of FIG. 2B, in accordance with one or more embodiments;

FIG. 3A is an oblique view of another example of a wastewater separator, shown with a batch recipient, in accordance with one or more embodiments; and

FIG. 3B is a sectional view of the wastewater separator of FIG. 3A taken along section 3B-3B of FIG. 3A, in accordance with one or more embodiments.

### DETAILED DESCRIPTION

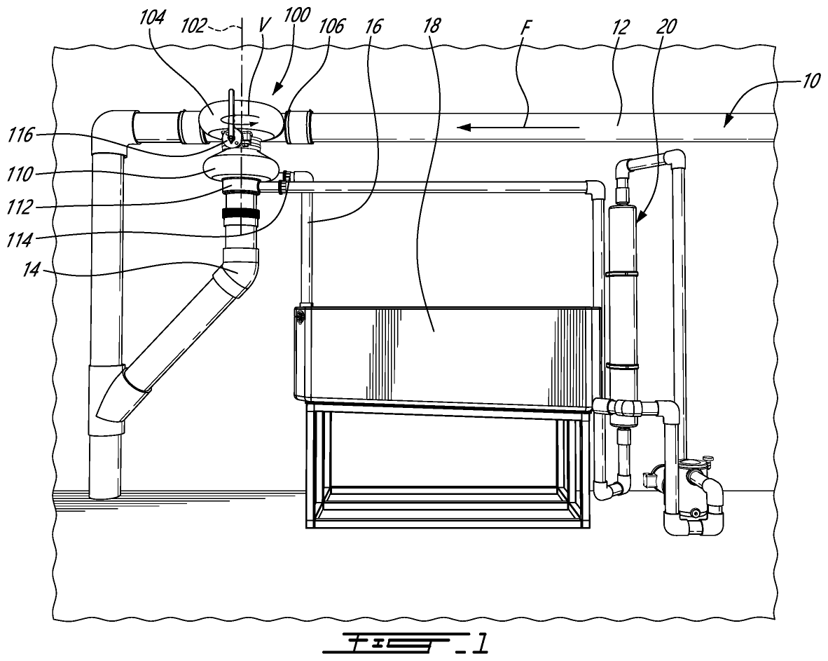

FIG. 1 shows an example of a wastewater heat exchanger 10, in accordance with an embodiment. As depicted, the wastewater heat exchanger 10 has a wastewater conduit 12 guiding a flow of wastewater F including solid matter such as feces and toilet paper, and liquid such as greywater. In some embodiments, the wastewater conduit 12 has an upstream port connected to one or more manifolds or other fluidic ports individually connected to water-consuming appliances used in the context of domestic, commercial, industrial and/or agricultural activities. Examples of water-consuming devices can include, but are not limited to, toilets, sinks, showers, washing machines, dishwashers, showers and the like.

The wastewater heat exchanger 10 is provided with a wastewater separator 100 in fluid communication with the wastewater conduit 12. As further described below, the wastewater separator 100 is configured for separating the solid matter from the liquid in a way that directs the solid matter along a solid conduit 14 and the liquid along a liquid conduit 16. More specifically, the wastewater separator 100 has a vortex axis 102 and an inlet chamber 104 defined around the vortex axis 102. The inlet chamber 104 has a wastewater inlet 106 in fluid communication with the wastewater conduit 12 and defines a vortex direction of rotation V. In some embodiments, the wastewater inlet 106 impinges tangentially to the inlet chamber 104 so as to promote circulation of the wastewater along the vortex direction of rotation V.

As shown, the wastewater separator 100 has an outlet chamber 110 defined around the vortex axis 102 below the inlet chamber 104. The outlet chamber 110 has a solid outlet 112 in fluid communication with the solid conduit 14 and a liquid outlet 114 in fluid communication with the liquid conduit 16. An annular neck 116 is provided between the inlet chamber 104 and the outlet chamber 10. As described further below, the annular neck 116 defines an opening at a bottom of the inlet chamber 104. The inlet chamber 104 tapers from the wastewater inlet 106 towards the annular neck 116 and the outlet chamber 110 inverse-tapers from the annular neck towards a bottom of the outlet chamber 110. With such a shape, the solid matter incoming from the wastewater inlet 106 is directed towards the annular neck 116 and tend to fall into the solid outlet 112 via the opening bound by the annular neck 116. The liquid incoming from the wastewater inlet 106 tend to be guided outwardly away from the solid outlet 112 and towards the liquid outlet 114. The guiding of the liquid is performed by the annular neck 116 that attracts and maintains relatively small flows of liquid along the inverse-taper shape of the outlet chamber 110 towards the liquid outlet 114.

It is understood that as the liquid carries thermal energy that is extractable and recyclable, the liquid can be directed towards a liquid reservoir 18 upstream to one or more heat exchanger units 20. The heat exchanger units 20 are configured for exchanging heat between the liquid stored in the liquid reservoir 18 and coolant liquid of a coolant liquid conduit (not shown) in thermal communication with the heat exchanger units 20. For instance, the heat exchange units 20 can exchange heat with a pump circulating liquid in “self-cleaning” greywater exchanger. Examples of such coolant liquid can include, but are not limited to, water, glycol and the like. In this way, used waters can be used for thermal energy recycling which can in turn lead to energy savings. Such a wastewater heat exchanger can be installed in domestic, commercial, industrial and/or agricultural buildings as a way to recycle thermal energy carried by wastewater which would be otherwise wasted in sewers. In some embodiments, the liquid reservoir 18 is only optional and can be omitted.

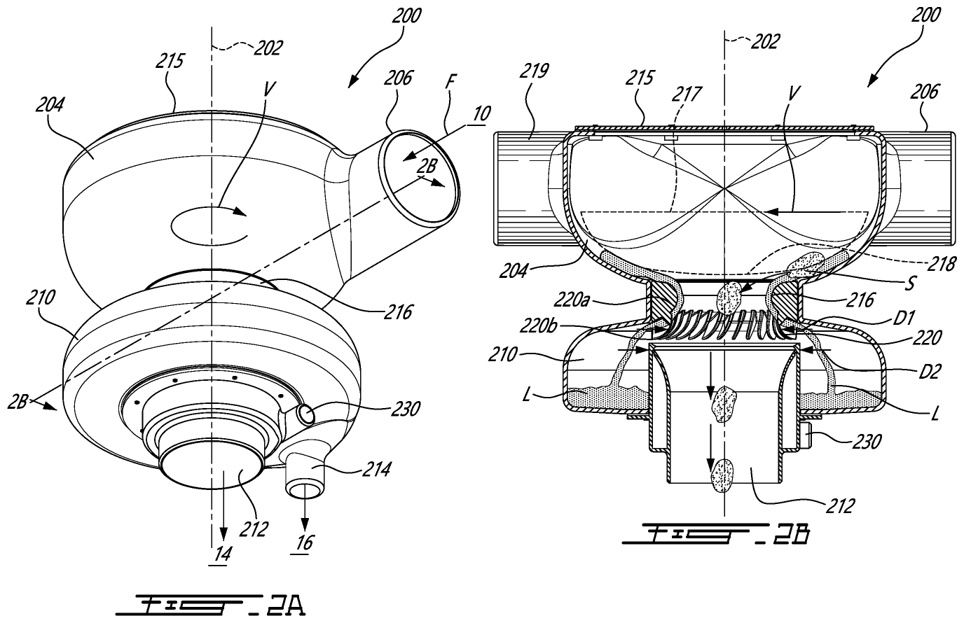

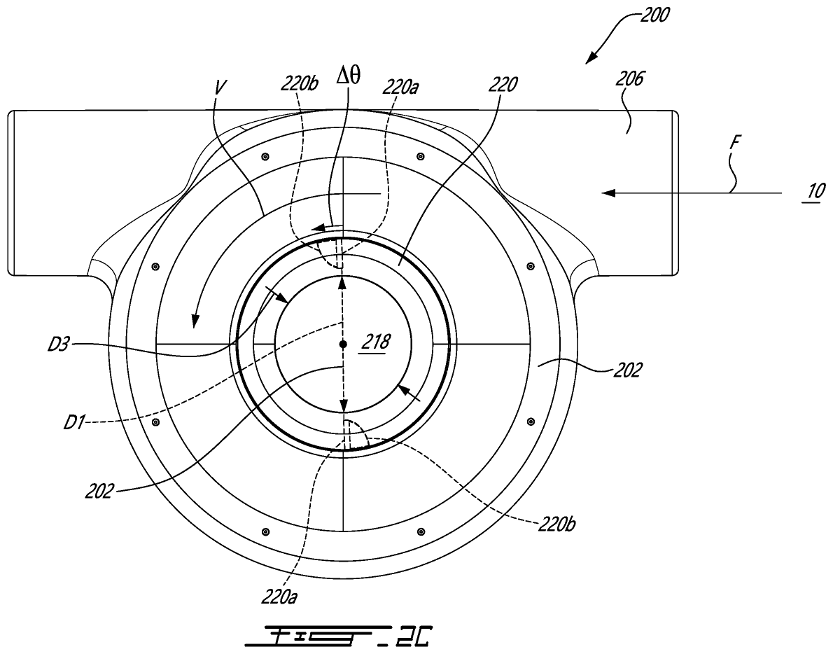

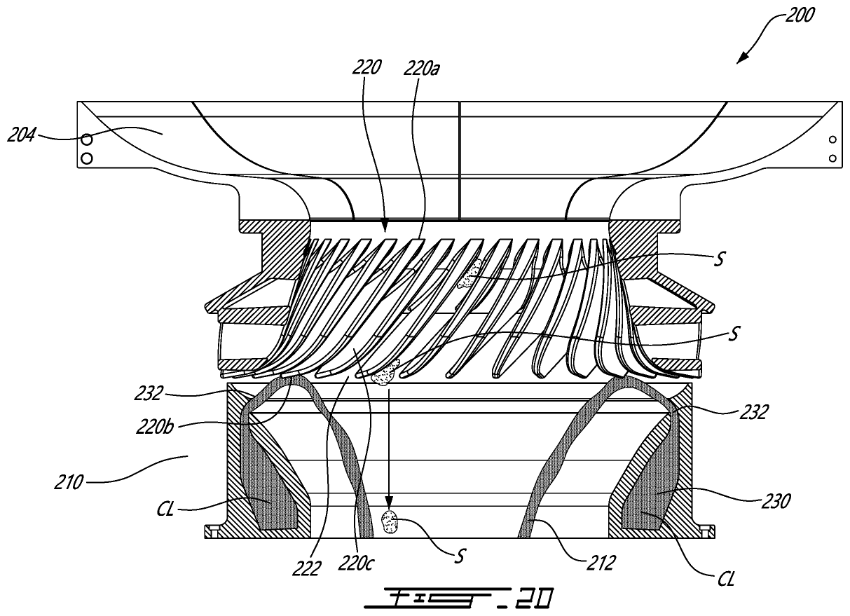

FIG. 2A shows an oblique view of another example of a wastewater separator 200. As shown, the wastewater separator 200 has a vortex axis 202 and an inlet chamber 204 defined around the vortex axis 202. The inlet chamber 204 has a wastewater inlet 206 in fluid communication with a wastewater conduit 20. The wastewater inlet 206 defines a vortex direction of rotation V within the inlet chamber 204. The wastewater inlet 206 is generally directed tangentially to the inlet chamber 204 thereby creating a spiral or vortex movement of wastewater in the inlet chamber 204. The wastewater separator 200 has an outlet chamber 210 defined around the vortex axis 202 below the inlet chamber 204. The outlet chamber 210 has a solid outlet 212 and a liquid outlet 214. When integrated to a wastewater heat exchanger such as described with reference to FIG. 1, the solid outlet 212 is in fluid communication with a solid conduit 14 and the liquid outlet 214 is in fluid communication with a liquid conduit 16.

As best shown in FIG. 2B, the wastewater separator 200 has an annular neck 216 extending between the inlet chamber 204 and the outlet chamber 210. As shown, the annular neck 216 defines an opening 218 at a bottom of the inlet chamber 204. The inlet chamber 204 tapers from the wastewater inlet 206 to the annular neck 216, and the outlet chamber 210 inverse-tapers from the annular neck 216 towards a bottom of the outlet chamber 204. The tapering and inverse-tapering can correspond to a respective one of a decrease and an increase in dimension, diameter, cross-section and the like along the vortex axis 202. In some embodiments, the inlet chamber 204, the annular neck 216 and the outlet chamber 210 collectively form an hourglass shape, with the annular neck 216 acting as the waist of the hourglass shape. As shown in this specific embodiment, the outlet chamber 210 has an annular shape surrounding the solid outlet 212. In these embodiments, the solid outlet 212 is axially disposed below the opening 218 and extending along the vortex axis 202 through the annular shape of the outlet chamber 210.

It is noted that, during use, the solid S carried in the flow of wastewater F generally tend to fall into the opening 218 and then into the solid outlet 212. In contrast, the liquid L general tends to be attracted to a generally convex shape of the annular neck 216 via Coandă effect which outwardly directs the liquid away from the solid outlet 212 and into the liquid outlet 214 of the outlet chamber 210. It is understood that for the attraction effect to be satisfactory, the volume of the flow of wastewater F is generally significantly lower than a capacity of the wastewater conduit 10. More specifically, the flow of wastewater F generally flows only onto a lower inside surface of the wastewater conduit 10 and of the wastewater inlet 206. In some embodiments, the wastewater separator 200 has a top lid 215 which is removably mounted to the inlet chamber 204. In some embodiments, an inlet chamber plug 217 sealingly closing the opening 218 can be put into a plug position when the flow of wastewater F is to be flowed through the wastewater separator 200 without separation. In some embodiments, the inlet chamber plug 217 can be selectively moved into the plug position covering the opening 218 or into a rest position away from the opening 218. In these embodiments, a mechanism for moving the inlet chamber plug 217 between the plug position and the rest position can be used to jam the opening 218 as desired. The mechanism can involve a lever or any suitable type of actuator. In such embodiments, the removable lid may be only optional. In embodiments where the inlet chamber plug 217 is in the plug position, the inlet chamber 204 can have a bypass outlet 219 leading away from the inlet chamber 204. For instance, the bypass outlet 219 can be in direct or indirect fluid communication with the solid conduit 14.

Still referring to FIG. 2B, the wastewater separator 200 has an assembly of angularly inclined fins 220 circumferentially distributed around the vortex axis 202 and axially located between the annular neck 216 and the solid outlet 212. Each angularly inclined fin 220 has an upper edge 220a in fluid communication with a lower portion of the annular neck 216 and a lower edge 220b which is circumferentially spaced apart from the upper edge 220a along the vortex direction of rotation V. In some embodiments, the assembly of angularly inclined fins 200 has an inner diameter D1 which is smaller than an inner diameter D2 of the solid outlet 212.

As best shown in FIG. 2C, the upper edge 220a has a first circumferential position and the lower edge 220b has a second circumferential position circumferentially spaced apart from the first circumferential position by an arc AO measured along (rather than against) the vortex direction of rotation V. In this way, the flow of wastewater F may impinge first on the upper edge 220a and then glide in a continuous and uninterrupted fashion towards the lower edge 220b. In some embodiments, the assembly of angularly inclined fins 220 includes at least 10 fins, preferably at least 15 fins and more preferably at least 20 fins. The number and/or dimensions of the fins 220 can depend on the dimensions of the wastewater separator. In some embodiments, the assembly of angularly inclined fins 220 has an inner diameter D1 which is greater than an inner diameter D3 of the opening 218. In this way, solid matter falling into the opening 218 have a lesser chance of reaching the fins 220. In some embodiments, the fins 220 are made of metal, polymers, composite material or any other suitable material. Preferably, the fins 220 are made of polymer. Injection or three-dimensional printing are preferred techniques for the manufacture of the fins 220. The fins 220 can be made of metal sheet as well in some other embodiments. Examples of such metal can include, but are not limited to, stainless steel, aluminum and the like. In embodiments where the fins are made of metal sheet, the fins can be pressed into form using corresponding moulds, for instance.

Referring now to FIG. 2D, each of the angularly inclined fins 220 has a lower surface 220c with a convex ending portion 222 leading to the lower edge 220b. The convex ending portion 222 has a function of gradually forcing tinier solid S that may be gliding along the fins 220 to fall into the solid outlet 212, thereby reducing risks of clogging or jamming. The fins 220 thereby act as a solid guide than as a scraper in this specific embodiment.

As shown, the outlet chamber 210 has a liquid inlet 230 which is annularly disposed around the solid outlet 212. In some embodiments, the liquid inlet 230 forms an annular nozzle 232 directed towards the assembly of angularly inclined fins 220. In a given mode of operation, cooler liquid CL for instance outputted from the wastewater heat exchanger can be flowed back into the wastewater separator 200 and more specifically into the annular nozzle 232 via the liquid inlet 230. When the cooler liquid CL is flowed back with sufficient pressure, the annular nozzle 232 can clean some or all the angularly inclined fins 220. In embodiments where the pressure would be insufficient for such a cleaning function, the cooler liquid CL may be flowed into the solid outlet 212 and out of the wastewater separator 200 for disposal. It is understood that the cooler liquid CL is cooler in this example as the heat exchanger extracts heat from the separated liquid L. However, in some other embodiments, the liquid CL may be hotter in some other air conditioning applications, for instance.

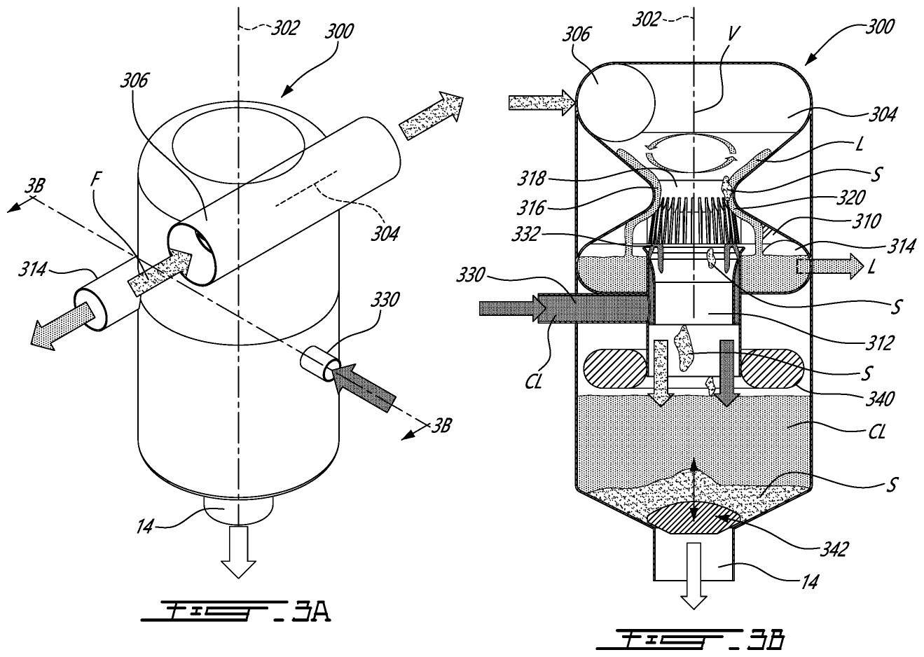

FIGS. 3A and 3B show another example of a wastewater separator 300 similar to the wastewater separator 200. More specifically, the wastewater separator 300 has a vortex axis 302 and an inlet chamber 304 defined around the vortex axis 302. The inlet chamber 304 has a wastewater inlet 306 defining a vortex direction of rotation V around the inlet chamber 304. An outlet chamber 310 defined around the vortex axis 302 below the inlet chamber 304 is also provided. As shown, the outlet chamber 310 has a solid outlet 312 and a liquid outlet 314. An annular neck 316 defined between the inlet chamber 304 and the outlet chamber 310 creates an opening 318 at a bottom of the inlet chamber 304. As shown, the inlet chamber 304 tapers to the annular neck 316 and the outlet chamber 310 inverse-tapers from the annular neck 316 to provide a Coandă-effect-enhancing shape such as an hourglass shape. Still in this example, the wastewater separator 300 is provided with an assembly of angularly inclined fins 320 circumferentially distributed around the vortex axis 302 and axially located between the annular neck 316 and the solid outlet 312. Each angularly inclined fin has an upper edge in fluid communication with a lower portion of the annular neck and a lower edge being circumferentially spaced apart from the upper edge along the vortex direction of rotation V.

In this specific example, a batch recipient 340 is provided below the wastewater separator 300. As shown, the batch recipient 340 is in fluid communication between the solid outlet 312 and a solid conduit 14. The batch recipient is provided with a batch plug 342 which is movable between a plug position blocking the opening of the solid conduit 14 and a rest position away from the opening of the solid conduit 14 to let a batch of material flow along the solid conduit 14. The batch plug 342 can be moved between the plug position and the rest position in back-and-forth sequences at a regular interval or at custom intervals. For instance, the batch plug 342 can be selectively moved based on a manual or electronically controllable actuator, sensor readings and the like. It was found that the solid S accumulating at the bottom of the batch recipient 340 may not be fluid enough to satisfactorily flow along the solid conduit 14. As such, by combining the solid matter and the cooled liquid CL returning from a wastewater heat exchanger into the batch recipient 340, a batch of cooled wastewater can be flowed in a more satisfactory fashion along the solid conduit 14 away towards sewers.

In another aspect, there is provide a method of separating a flow of wastewater using a separator such as the ones described above. The method has a step of circulating a flow of wastewater in a vortex within the inlet chamber, a step in which the annular neck guides some circulating liquid of the flow outwardly around a solid outlet axially extending within the outlet chamber and into the outlet chamber, and a step of guiding some circulating solid matter of the flow into the opening towards the solid outlet using the assembly of angularly inclined fins. As such, the fins defining paths which are a continuity to the vortex of the inlet chamber, thereby avoiding solid clogging and jamming. In some embodiments, some circulating liquid of the flow or cooled liquid returning from a wastewater heat exchanger may be used for rinsing and thereby cleaning the assembly of angularly inclined fins.

As can be understood, the examples described above and illustrated are intended to be exemplary only. The scope is indicated by the appended claims.

What is claimed is:

1. A wastewater separator for separating a flow of wastewater having solid matter and liquid, the wastewater separator comprising:
a vortex axis;
an inlet chamber defined around the vortex axis and having a wastewater inlet defining a vortex direction of rotation;
an outlet chamber defined around the vortex axis below the inlet chamber and having a solid outlet and a liquid outlet;
an annular neck between the inlet chamber and the outlet chamber and defining an opening at a bottom of the inlet chamber, the inlet chamber tapering to the annular neck and the outlet chamber inverse-tapering from the annular neck; and
an assembly of angularly inclined fins circumferentially distributed around the vortex axis and axially located between the annular neck and the solid outlet, the angularly inclined fins having an upper edge in fluid communication with a lower portion of the annular neck and a lower edge circumferentially spaced apart from the upper edge along the vortex direction of rotation.

2. The wastewater separator of claim 1 wherein the angularly inclined fin are made of polymer.

3. The wastewater separator of claim 1 wherein the angularly inclined fins have a lower surface with a convex ending portion leading to the lower edge.

4. The wastewater separator of claim 1 wherein the assembly of angularly inclined fins includes at least 10 fins, preferably at least 15 fins and more preferably at least 20 fins.

5. The wastewater separator of claim 1 wherein the assembly of angularly inclined fins has an inner diameter being greater than an inner diameter of the opening.

6. The wastewater separator of claim 1 wherein the inlet chamber has a top lid removably mounted to the inlet chamber.

7. The wastewater separator of claim 1 wherein the outlet chamber has an annular shape, the solid outlet being axially disposed below the opening and extending along the vortex axis through the annular shape of the outlet chamber.

8. The wastewater separator of claim 7 wherein the assembly of angularly inclined fins has an inner diameter being smaller than an inner diameter of the solid outlet.

9. The wastewater separator of claim 7 wherein the outlet chamber has a liquid inlet being annularly disposed around the solid outlet.

10. The wastewater separator of claim 9 wherein the liquid inlet forms an annular nozzle directed towards the assembly of angularly inclined fins.

11. The wastewater separator of claim 1 further comprising a batch recipient in fluid communication with the solid outlet for accumulating a batch of solid matter.

12. A method of separating a flow of wastewater using a separator having a vortex axis, an inlet chamber defined around the vortex axis, an outlet chamber defined around the vortex axis below the inlet chamber, an annular neck between the inlet chamber and the outlet chamber and defining an opening at a bottom of the inlet chamber, the method comprising:
circulating the flow of wastewater in a vortex within the inlet chamber;
the annular neck guiding some circulating liquid of the flow outwardly around a solid outlet axially extending within the outlet chamber and into the outlet chamber; and
using an assembly of angularly inclined fins distributed around the vortex axis and axially located between the annular neck and the solid outlet, guiding some circulating solid matter of the flow into the opening towards the solid outlet, the fins defining paths being continuous to the vortex of the inlet chamber.

13. The method of claim 12 wherein some circulating liquid of the flow cleaning the assembly of angularly inclined fins.

14. A wastewater heat exchanger comprising:
a wastewater conduit;
a wastewater separator having a vortex axis, an inlet chamber defined around the vortex axis, the inlet chamber having a wastewater inlet in fluid communication with the wastewater conduit and defining a vortex direction of rotation, an outlet chamber defined around the vortex axis below the inlet chamber and having a solid outlet and a liquid outlet, an annular neck between the inlet chamber and the outlet chamber and defining an opening at a bottom of the inlet chamber, the inlet chamber tapering to the annular neck and the outlet chamber inverse-tapering from the annular neck; and
a heat exchanger unit having a coolant liquid inlet and a separated liquid inlet in fluid communication with the liquid outlet of the wastewater separator, the heat exchanger unit being configured for exchanging heat between the liquid received from the liquid outlet of the wastewater separator and coolant liquid of the coolant liquid inlet.

15. The wastewater heat exchanger of claim 14 wherein the wastewater separator further comprises an assembly of angularly inclined fins circumferentially distributed around the vortex axis and axially located between the annular neck and the solid outlet, the angularly inclined fins having an upper edge in fluid communication with a lower portion of the annular neck and a lower edge circumferentially spaced apart from the upper edge along the vortex direction of rotation.

16. The wastewater heat exchanger of claim 15 wherein the angularly inclined fins are made of polymer.

17. The wastewater heat exchanger of claim 15 wherein the angularly inclined fins have a lower surface with a convex ending portion leading to the lower edge.

18. The wastewater heat exchanger of claim 15 wherein the assembly of angularly inclined fins includes at least 10 fins, preferably at least 15 fins and more preferably at least 20 fins.

19. The wastewater heat exchanger of claim 15 wherein the assembly of angularly inclined fins has an inner diameter being greater than an inner diameter of the opening.

20. The wastewater heat exchanger of claim 14 wherein the inlet chamber has a top lid removably mounted to the inlet chamber.
